(19) United States
(12) Patent Application Publication
(10) Pub. No.: US 2018/0356761 A1
(43) Pub. Date: Dec. 13, 2018

(54) ROLLER MEMBER, TRANSPORT DEVICE, AND IMAGE FORMING APPARATUS

(71) Applicant: FUJI XEROX CO., LTD., Tokyo (JP)

(72) Inventors: Takashi ANZAI, Kanagawa (JP); Toshiyuki MIYATA, Kanagawa (JP); Yasunori FUJIMOTO, Kanagawa (JP); Takahito CHIBA, Kanagawa (JP); Keisuke SHIMOJO, Kanagawa (JP); Masataka KONISHI, Kanagawa (JP)

(73) Assignee: FUJI XEROX CO., LTD., Tokyo (JP)

(21) Appl. No.: 15/942,560

(22) Filed: Apr. 1, 2018

(30) Foreign Application Priority Data
Jun. 13, 2017 (JP) 2017-115696

(51) Int. Cl. G03G 15/00; B65H 5/06

(52) U.S. Cl. CPC G03G 15/6529; G03G 2215/00679; B65H 5/062; G03G 15/2014

(57) ABSTRACT

A roller member includes a rotating shaft and a roller portion. The roller portion includes a first layer provided on at least a portion of an outer peripheral surface of the rotating shaft, and a second elastic layer provided on at least a portion of an outer peripheral surface of the first layer. The first layer is made of a material having a coefficient of linear expansion lower than a coefficient of linear expansion of a material of the second elastic layer.

### CROSS-REFERENCE TO RELATED APPLICATIONS

This application is based on and claims priority under 35 USC 119 from Japanese Patent Application No. 2017-115696 filed Jun. 13, 2017.

### BACKGROUND

### Technical Field

The present invention relates to a roller member, a transport device, and an image forming apparatus.

### SUMMARY

According to an aspect of the invention, there is provided a roller member including a rotating shaft and a roller portion. The roller portion includes a first layer provided on at least a portion of an outer peripheral surface of the rotating shaft, and a second elastic layer provided on at least a portion of an outer peripheral surface of the first layer. The first layer is made of a material having a coefficient of linear expansion lower than a coefficient of linear expansion of a material of the second elastic layer.

### BRIEF DESCRIPTION OF THE DRAWINGS

Exemplary embodiments of the present invention will be described in detail based on the following figures, wherein:

FIG. 1 illustrates the structure of an image forming apparatus according to a first exemplary embodiment and other exemplary embodiments;

FIG. 2 is an enlarged view illustrating a part of the image forming apparatus illustrated in FIG. 1 (transport paths including a discharge transport path disposed near a fixing device) in a certain state;

FIG. 3 illustrates the part of the image forming apparatus illustrated in FIG. 1 in another state;

FIGS. 4A to 4C illustrate the transport paths and a recording sheet in a double-sided image forming operation;

FIG. 5 is a partially sectioned view illustrating the structure of a transport device according to the first exemplary embodiment viewed from substantially vertically above;

FIG. 6A is a schematic sectional view of a driving roller included in the transport device illustrated in FIG. 5 taken along a vertical plane perpendicular to an axial direction, and FIG. 6B is a schematic sectional view of the driving roller taken along a horizontal plane parallel to the axial direction;

FIG. 7A is a schematic sectional view of a driven roller included in the transport device illustrated in FIG. 5 taken along a vertical plane perpendicular to the axial direction, and FIG. 7B is a schematic sectional view of the driven roller taken along a horizontal plane parallel to the axial direction;

FIG. 8 is a partially sectioned view illustrating the manner in which a recording sheet is transported by the transport device illustrated in FIG. 5;

FIG. 9A is a schematic sectional view of a roller member that serves as a driving roller of a transport device according to a second exemplary embodiment taken along a vertical plane perpendicular to an axial direction, and FIG. 9B is a schematic sectional view of the roller member illustrated in FIG. 9A taken along a horizontal plane parallel to the axial direction;

FIG. 10A is a schematic sectional view of an example of a roller member that serves as a driving roller of a transport device according to a third exemplary embodiment taken along a horizontal plane parallel to an axial direction, and FIG. 10B is a schematic sectional view of another example of a roller member taken along a horizontal plane parallel to an axial direction;

FIG. 11A is a partially sectioned view illustrating the structure of the transport device according to the third exemplary embodiment viewed from substantially vertically above, and FIG. 11B is a partially sectioned view illustrating the manner in which a recording sheet is transported by the transport device;

FIG. 12 is a schematic sectional view of another example of a roller member that serves as the driving roller of the transport device according to the third exemplary embodiment taken along a horizontal plane parallel to the axial direction;

FIG. 13A illustrates a maximum passage width of a recording sheet and an example of a roller member that serves as a sheet feed roller of a transport device according to a fourth exemplary embodiment, and FIG. 13B illustrates the maximum passage width of the recording sheet and another example of a sheet feed roller;

FIG. 14 is a partially sectioned view illustrating the structure of the transport device according to a fifth exemplary embodiment viewed from substantially vertically above;

FIG. 15A is a schematic sectional view of a roller member that serves as a driving roller of a comparative example according to the related art taken along a vertical plane perpendicular to an axial direction, and FIG. 15B is a schematic sectional view of the roller member illustrated in FIG. 15A taken along a horizontal plane parallel to the axial direction; and

FIG. 16 is an enlarged view illustrating an example of the manner in which a recording sheet is transported in an image forming apparatus including the driving roller (roller member) illustrated in FIGS. 15A and 15B as a driving roller of a third discharge roller pair.

### DETAILED DESCRIPTION

Exemplary embodiments of the present invention will now be described with reference to the drawings.

### First Exemplary Embodiment

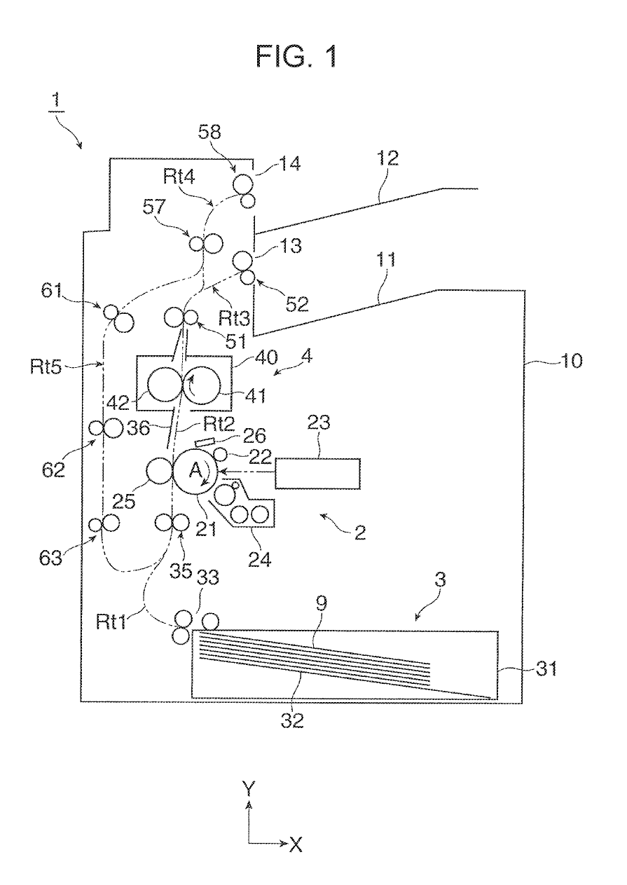

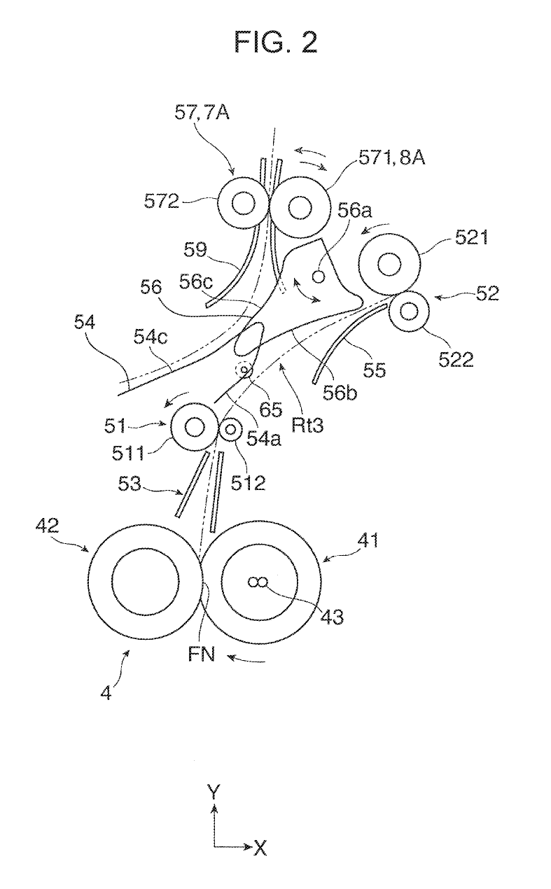

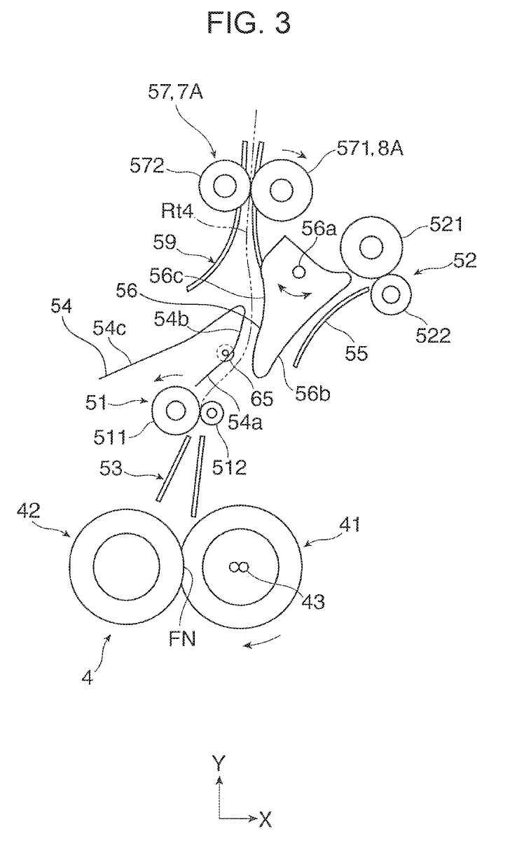

FIGS. 1 to 3 illustrate a first exemplary embodiment of the present invention. FIG. 1 illustrates the structure of an image forming apparatus 1 according to the first exemplary embodiment. FIG. 2 is an enlarged view illustrating a part of the image forming apparatus 1 illustrated in FIG. 1 (transport paths including a discharge transport path disposed near a fixing device) in a certain state. FIG. 3 illustrates the part illustrated in FIG. 2 in another state.

### Overall Structure of Image Forming Apparatus

The image forming apparatus 1 forms an image including, for example, characters, photographs, and graphics on a recording sheet 9, which is an example of a transport object, by using developer (toner) on the basis of information of the image.

As illustrated in FIG. 1, the image forming apparatus 1 includes an image forming device 2, a sheet supplying device 3, a fixing device 4, and a roller member 8A, all of which are disposed in a housing 10 that serves as an apparatus body. The image forming device 2 is, for example, an electrophotographic device that forms a toner image by using toner, which serves as developer, and transfers the toner image onto a recording sheet 9. The sheet supplying device contains certain recording sheets 9 and supplies each recording sheet 9 to a transfer position of the image forming device 2. The fixing device 4 fixes the toner image that has been transferred to the recording sheet 9.

The housing 10 includes various members, such as structural members and facing members. Two discharged-sheet-receiving portions (first discharged-sheet-receiving portion 11 and second discharged-sheet-receiving portion 12) for receiving the recording sheet 9 that is discharged after an image is formed thereon are provided above the housing 10.

The first discharged-sheet-receiving portion 11 includes a receiving surface formed of an inclined surface disposed below a first discharge hole 13 in the housing 10, and receives the recording sheet 9 when the recording sheet 9 is discharged through the first discharge hole 13. The second discharged-sheet-receiving portion 12 includes a plate-shaped receiving member having an inclined surface arranged to project below a second discharge hole 14 in the housing 10, and receives the recording sheet 9 when the recording sheet 9 is discharged through the second discharge hole 14.

The image forming device 2 includes a charging device 22, an exposure device 23, a developing device 24, a transfer device 25, and a cleaning device 26, which are arranged in that order around a photoconductor drum 21 that is rotationally driven in the direction indicated by arrow A.

The charging device 22 is a contact charging device that charges a peripheral surface of the photoconductor drum (portion of the outer peripheral surface that serves as an image forming region) to a predetermined potential of a predetermined polarity. The exposure device 23 forms an electrostatic latent image by irradiating the charged peripheral surface of the photoconductor drum 21 with light (arrow with two-dot chain line) corresponding to image information (signals) input to the image forming apparatus 1 in various formats. The developing device 24 develops the electrostatic latent image on the photoconductor drum 21 into a toner image by supplying toner, which serves as developer, to the electrostatic latent image. The transfer device 25 is a contact transfer device that electrostatically transfers the toner image on the photoconductor drum 21 to the recording sheet 9. The cleaning device 26 cleans the peripheral surface of the photoconductor drum 21 by removing unnecessary substances, such as residual toner, therefrom.

The sheet supplying device 3 includes a sheet container 31 and a feeding device 33. The sheet container 31 contains plural recording sheets 9 of a certain size, type, etc., on which images are to be formed, in such a manner that the recording sheets 9 are stacked on a stacking plate 32. The feeding device 33 feeds the recording sheets 9 contained in the sheet container 31 one at a time.

The sheet container 31 is attached to the housing 10 in such a manner that the sheet container 31 may be pulled out of the housing 10. Plural sheet containers 31 may be provided as necessary. Examples of the recording sheets 9 include recording media such as plain paper, coated paper, and cardboard cut into a predetermined size.

The fixing device 4 includes a housing 40 having an inlet and an outlet. A heating rotating body 41 and a pressing rotating body 42, which rotate while being in contact with each other, are disposed in the housing 40.

As illustrated in FIGS. 1 and 2 and other drawings, the heating rotating body 41 is a heating fixing member having the shape of a roller, belt, or the like that is rotationally driven in the direction indicated by the arrow and that is heated by a heating unit 43 so that the temperature of a peripheral surface thereof is maintained at a certain temperature. The pressing rotating body 42 is a pressing fixing member having the shape of a roller, belt, or the like that is in pressure contact with the heating rotating body 41 substantially along an axial direction at a certain pressure, and is rotated by the heating rotating body 41. A portion of the fixing device 4 in which the heating rotating body 41 and the pressing rotating body 42 are in contact with each other serves as a fixing process portion FN which performs a certain fixing process (heating, pressing, etc.) on each recording sheet 9 with an unfixed toner image when the recording sheet 9 passes therethrough.

### Structure of Transport Paths

Referring to FIG. 1, the image forming apparatus 1 includes transport paths Rt, shown by the two-dot chain lines, along which the recording sheet 9 is transported in the housing 10. The transport paths Rt include a supply transport path Rt1, a relay transport path Rt2, a first discharge transport path Rt3, a second discharge transport path Rt4, and a both-sided-printing transport path Rt5.

The supply transport path Rt1 connects the feeding device 33 of the sheet supplying device 3 to the transfer position of the image forming device 2 (position at which the photoconductor drum 21 faces the transfer device 25). The supply transport path Rt1 is constituted by a transport roller pair 35 and plural transport guide members (not shown). The transport roller pair 35 is a so-called registration roller pair that serves a function of straightening the transported recording sheet 9 when it is not rotated and that also serves a function of feeding the recording sheet 9 to the transfer position by rotating in accordance with the timing of the above-described transfer process.

The relay transport path Rt2 connects the transfer position of the image forming device 2 to the fixing process portion of the fixing device 4. The transport path Rt2 is constituted by a certain transport guide member 36.

The first discharge transport path Rt3 connects the fixing process portion of the fixing device 4 to the first discharge hole 13. The first discharge transport path Rt3 is constituted by a first discharge roller pair 51, a second discharge roller pair 52, plural discharge guide members 53, 54, and 55, and a path switching member 56.

The first discharge roller pair 51 is disposed near the outlet in the housing 40 of the fixing device 4, and includes a driving roller 511 that is rotationally driven and a driven roller 512 that is pressed against and rotated by the driving roller 511. The second discharge roller pair is disposed near the first discharge hole 13, and includes a driving roller 521 that is rotationally driven and a driven roller 522 that is in contact with and rotated by the driving roller 521.

The discharge guide member 53 includes a pair of members that guide the recording sheet 9 toward the first discharge roller pair 51 after the fixing process. The discharge guide member 54 guides the recording sheet 9 discharged from the first discharge roller pair 51 toward the second discharge roller pair 52. The discharge guide member 55 operates together with the path switching member (first guide portion 56b) to guide the recording sheet 9 toward the second discharge roller pair 52.

As illustrated in FIGS. 2 and 3, the discharge guide member 54 includes a first guide portion 54a that guides the recording sheet 9 so that the recording sheet 9 is bent obliquely sideways toward the second discharge roller pair 52; a second guide portion 54b that guides the recording sheet 9 so that the recording sheet 9 is bent obliquely upward; and a third guide portion 54c that guides the recording sheet 9 so that the recording sheet 9 is bent obliquely downward toward the both-sided-printing transport path Rt5. The first guide portion 54a, the second guide portion 54b, and the third guide portion 54c are formed of end portions of plate-shaped members (ribs) that are arranged with gaps therebetween in the axial direction of the discharge roller pairs.

As illustrated in FIGS. 2 and 3 and other drawings, the path switching member 56 rotates around a support shaft 56a as shown by the double sided arrow and stops at an upper position or a lower position. As illustrated in FIGS. 2 and 3, the path switching member 56 includes a first guide portion 56b and a second guide portion 56c. The first guide portion 56b operates together with the first guide portion 54a of the discharge guide member 54 and faces the discharge guide member 55 to form a portion of the first discharge transport path Rt3. The second guide portion 56c faces the second guide portion 54b of the discharge guide member 54 to form a portion of the second discharge transport path Rt4, and operates together with the third guide portion 54c of the discharge guide member 54 to form a portion of the both-sided-printing transport path Rt5 that is connected to the second discharge transport path Rt4.

When the first discharge transport path Rt3 is to be formed, the path switching member 56 rotates to and stops at the upper position, as illustrated in FIG. 2. When the path switching member 56 is at this position, the second discharge transport path Rt4 and the both-sided-printing transport path Rt5 are connected to each other, and the path switching member 56 forms a portion of the second discharge transport path Rt4.

The second discharge transport path Rt4 connects the fixing process portion of the fixing device 4 to the second discharge hole 14. The second discharge transport path Rt4 branches from the first discharge transport path Rt3, and is constituted by a portion of the first discharge transport path Rt3 (the discharge guide members 53 and 54 and the path switching member 56), a third discharge roller pair 57, a fourth discharge roller pair 58, and plural discharge guide members 59.

When the second discharge transport path Rt4 is to be formed, the path switching member 56 rotates to and stops at the lower position, as illustrated in FIG. 3. Thus, the second guide portion 56c of the path switching member 56 and the second guide portion 54b of the discharge guide member 54 face each other to form a portion of the second discharge transport path Rt4 that branches from the first discharge transport path Rt3.

As illustrated in FIG. 3, the third discharge roller pair 57 is disposed above the path switching member 56, and includes a driving roller 571 that is rotatably driving in forward and reverse directions and a driven roller 572 that is pressed against and rotated by the driving roller 571. The fourth discharge roller pair 58 is disposed near the second discharge hole 14, and includes a driving roller that is rotatably driven and a driven roller that is rotated by the driving roller.

The discharge guide member 59 includes a pair of members that guide the recording sheet 9 toward the third discharge roller pair 57.

As illustrated in FIG. 1, the both-sided-printing transport path Rt5 connects an intermediate portion (branching portion) of the second discharge transport path Rt4 to an intermediate portion (joining portion) of the supply transport path Rt1. The both-sided-printing transport path Rt5 branches from the second discharge transport path Rt4, and is constituted by a portion of the second discharge transport path Rt4 (the path switching member 56, the third discharge roller pair 57, and the discharge guide members 54 and 59), a first transport roller pair 61, a second transport roller pair 62, a third transport roller pair 63, and plural transport guide members (not shown).

When the both-sided-printing transport path Rt5 is to be formed, the path switching member 56 rotates to and stops at the upper position, as illustrated in FIG. 2, as in the case where the first discharge transport path Rt3 is to be formed. Accordingly, the second guide portion 56c of the path switching member 56 operates together with the third guide portion 54c of the discharge guide member 54 to form a portion of the both-sided-printing transport path Rt5 that branches from the second discharge transport path Rt4.

As illustrated in FIG. 1, the first to third transport roller pairs 61 to 63 are arranged in that order from the upstream end of the both-sided-printing transport path Rt5 with predetermined gaps therebetween. Each of the first to third transport roller pairs 61 to 63 includes a driving roller that is rotationally driven and a driven roller that is pressed against and rotated by the driving roller.

A portion of the discharge guide member 59 is shaped so as to face the second guide portion 56c of the path switching member 56 to form an inlet of the both-sided-printing transport path Rt5. The transport guide members (not shown) include a guide member that guides the recording sheet 9 that has passed through the third transport roller pair 63 so that the recording sheet 9 is bent and enters the supply transport path Rt1 at a position upstream of the transport roller pair 35.

### Image Forming Operation Performed by Image Forming Apparatus

The image forming apparatus 1 forms an image as described below.

A single-sided image forming operation in which an image is formed on one side of the recording sheet 9 will now be described.

When a controller (not shown) of the image forming apparatus 1 receives a request for the single-sided image forming operation, the image forming device 2, the fixing device 4 and other devices are activated.

First, in the image forming device 2, the photoconductor drum 21 starts to rotate, and the charging device 22 charges the peripheral surface of the photoconductor drum 21 to a predetermined potential of a predetermined polarity (negative in this example). Then, the exposure device 23 irradiates the charged peripheral surface of the photoconductor drum 21 with light based on image information to form an electrostatic latent image having a predetermined pattern. Subsequently, the developing device 24 supplies toner, which is developer charged to a predetermined polarity (negative in this example), to the electrostatic latent image formed on the peripheral surface of the photoconductor drum 21, thereby developing the electrostatic latent image into a toner image.

After that, the photoconductor drum 21 rotates to transport the toner image to the transfer position at which the toner image faces the transfer device 25. The sheet supplying device 3 operates in accordance with the timing of the transfer process so that the recording sheet 9 is fed to the supply transport path Rt1 by the feeding device 33 and transported to the transfer position of the image forming device 2. At the transfer position of the image forming device 2, the transfer device 25 basically electrostatically transfers the toner image on the photoconductor drum 21 to one side of the recording sheet 9 transported along the supply transport path Rt1 by the registration roller pair 35. After the transfer process, the cleaning device 26 cleans the peripheral surface of the photoconductor drum 21 to prepare for the next image forming operation.

Subsequently, in the image forming device 2, the photoconductor drum 21, which is rotationally driven, guides the recording sheet 9 to which the toner image has been transferred to the relay transport path Rt2, so that the recording sheet 9 is transported toward the fixing device 4. In the fixing device 4, the recording sheet 9 is guided through the fixing process portion FN between the heating rotating body 41, which is rotationally driven, and the pressing rotating body 42. When the recording sheet 9 passes through the fixing process portion FN, the toner that forms the toner image on one side of the recording sheet 9 is heated and melted while being pressed, and is thereby fixed to the recording sheet 9.

Finally, the recording sheet 9 to which the toner is fixed is discharged to and received by the first discharged-sheet-receiving portion 11 or the second discharged-sheet-receiving portion 12.

When the recording sheet 9 is to be received by the first discharged-sheet-receiving portion 11, the path switching member 56 rotates to and stops at the upper position, as illustrated in FIG. 2. Thus, the first discharge transport path Rt3 is formed.

In this case, when the recording sheet 9 to which the toner is fixed is discharged from the fixing process portion FN of the fixing device 4, the recording sheet 9 is guided to the first discharge roller pair 51, which is rotationally driven, by the discharge guide member 53, which forms an upstream portion of the first discharge transport path Rt3. After that, the recording sheet 9 is nipped by the first discharge roller pair 51 and receives a transporting force so that the recording sheet 9 is guided by the discharge guide member 54 (first guide portion 54a) and the path switching member 56 (first guide portion 56b), which basically form a downstream portion of the first discharge transport path Rt3, and transported to the second discharge roller pair 52, which is rotationally driven.

Finally, the recording sheet 9 is nipped by the second discharge roller pair 52 and receives a transporting force so that the recording sheet 9 is discharged through the first discharge hole 13 and received by the first discharged-sheet-receiving portion 11.

When the recording sheet 9 is to be received by the second discharged-sheet-receiving portion 12, the path switching member 56 rotates to and stops at the lower position, as illustrated in FIG. 3. Thus, the second discharge transport path Rt4 is formed.

In this case, when the recording sheet 9 to which the toner is fixed is discharged from the fixing process portion FN of the fixing device 4, the recording sheet 9 is guided to the first discharge roller pair 51, which is rotationally driven, by the discharge guide member 53, which forms the upstream portion of the first discharge transport path Rt3. After that, the recording sheet 9 is guided basically by the path switching member 56 (second guide portion 56c) at the branching point of the first discharge transport path Rt3, and is transported to the second discharge transport path Rt4. Then, the recording sheet 9 is guided to the third discharge roller pair 57, which is rotationally driven, by the discharge guide member 59. Subsequently, the recording sheet 9 is nipped by the third discharge roller pair 57 and receives a transporting force so that the recording sheet 9 is transported through a downstream portion of the second discharge transport path Rt4 to the fourth discharge roller pair 58, which is rotationally driven.

Finally, the recording sheet 9 is nipped by the fourth discharge roller pair 58 and receives a transporting force so that the recording sheet 9 is discharged through the second discharge hole 14 and received by the second discharged-sheet-receiving portion 12.

Thus, the single-sided image forming operation for forming a monochrome image on one side of a single recording sheet 9 by using toner of a single color is completed. When a command for performing the image forming operation on plural sheets is issued, the above-described operation is repeated a number of times equal to the number of sheets.

A double-sided image forming operation for forming images on both front and back sides of the recording sheet 9 will now be described.

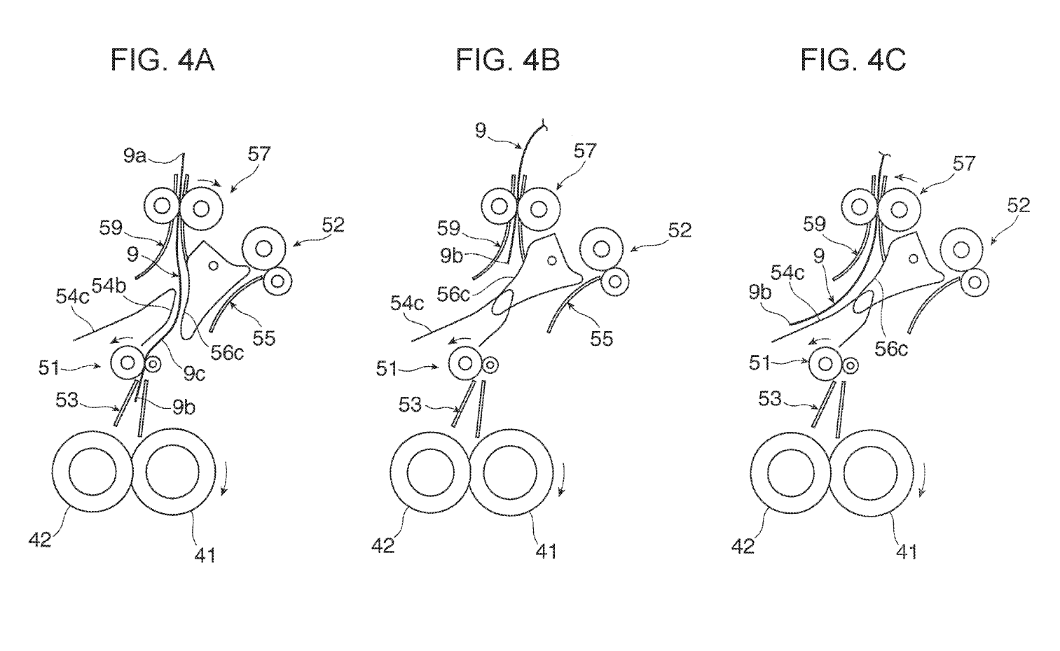

In this case, the above-described single-sided image forming operation is performed, and then the recording sheet 9 on which the toner image is fixed to one side thereof is temporarily guided to the second discharge transport path Rt4, as illustrated in FIGS. 3 and 4A. The path switching member 56 rotates to and stops at the lower position to form the second discharge transport path Rt4. In FIG. 4A, the leading end of the recording sheet 9 guided to the second discharge transport path Rt4 is denoted by 9a.

Subsequently, when a trailing end 9b of the recording sheet 9 guided to the second discharge transport path Rt4 reaches a position immediately in front of the third discharge roller pair 57, as illustrated in FIG. 4B, the third discharge roller pair 57 stops rotating and the recording sheet 9 stops accordingly. When the recording sheet 9 stops, as illustrated in FIG. 4B, the path switching member 56 rotates to and stops at the upper position. Thus, the both-sided-printing transport path Rt5, which branches from the second discharge transport path Rt4, is formed.

After that, as illustrated in FIG. 4C, the third discharge roller pair 57 starts to rotate in the reverse direction. Accordingly, the recording sheet 9 that has been stopped is guided to the both-sided-printing transport path Rt5 by the path switching member 56 (second guide portion 56c) and the transport member 54 (third guide portion 54c) in such a manner that the trailing end 9b thereof serves as the leading end.

Subsequently, the recording sheet 9 guided to the both-sided-printing transport path Rt5 is successively transported through the first to third transport roller pairs 61 to 63, which are rotationally driven, and is guided to a position in front of the transport roller pair 35 on the supply transport path Rt1. Thus, the recording sheet 9 is guided to the supply transport path Rt1 in a reversed state.

Then, similar to the above-described single-sided image forming operation, the recording sheet 9 is fed to the transfer position of the image forming device 2 in accordance with the timing of the transfer process so that a toner image is transferred to the back side thereof. Then, the recording sheet 9 is transported to the fixing device 4, where the toner image is fixed thereto. After that, the recording sheet 9 having images fixed to both front and back sides thereof is discharged to the first discharged-sheet-receiving portion 11 or the second discharged-sheet-receiving portion 12 in the above-described manner.

Thus, the double-sided image forming operation for forming monochrome images on one side (first side) and the other side (second side) of a single recording sheet 9 by using toner of a single color is completed.

### Structure of Transport Device and Roller Members

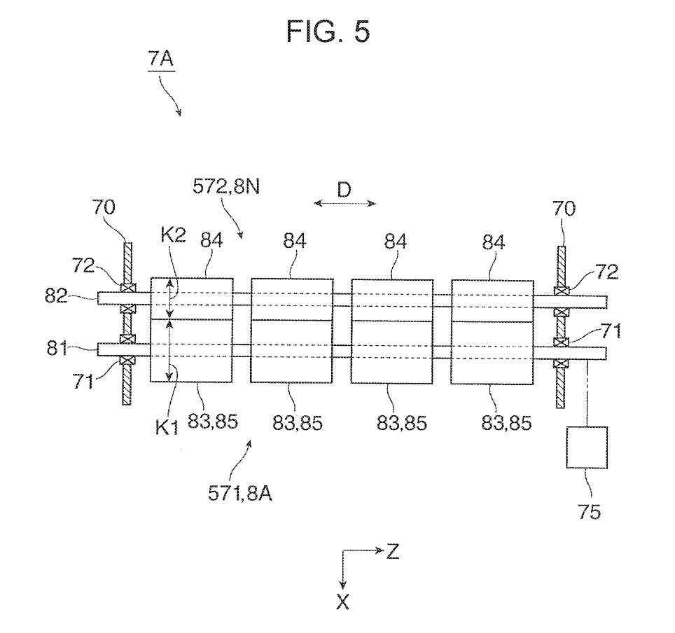

In the image forming apparatus 1, the third discharge roller pair 57 provided on the second discharge transport path Rt4 is constituted by a transport device 7A illustrated in FIG. 5.

As illustrated in FIG. 5, the transport device 7A is structured such that the driving roller 571 and the driven roller 572 included in the third discharge roller pair 57 are rotatably supported by support members 70, and such that the required rotational driving force is transmitted to the driving roller 571 from a driving device 75. The rotational driving force is transmitted from the driving device 75 to the driving roller 571 through a rotation transmission mechanism (not shown) including, for example, a gear train. The driving device 75 is capable of generating the rotational driving force in a direction switchable between forward and reverse directions.

In the transport device 7A, roller members 8A and 8N are used as the driving roller 571 and the driven roller 572, respectively. The roller members 8A and 8N respectively include rotating shafts 81 and 82, which are rotatably supported by bearings 71 and 72 attached to the support members 70, and roller portions 83 and 84. Plural roller portions 83 (four roller portions 83 in this example) are fixed to the rotating shaft 81 with gaps therebetween in an axial direction D, and plural roller portions 84 (four roller portions 84 in this example) are fixed to the rotating shaft 82 with gaps therebetween in the axial direction D.

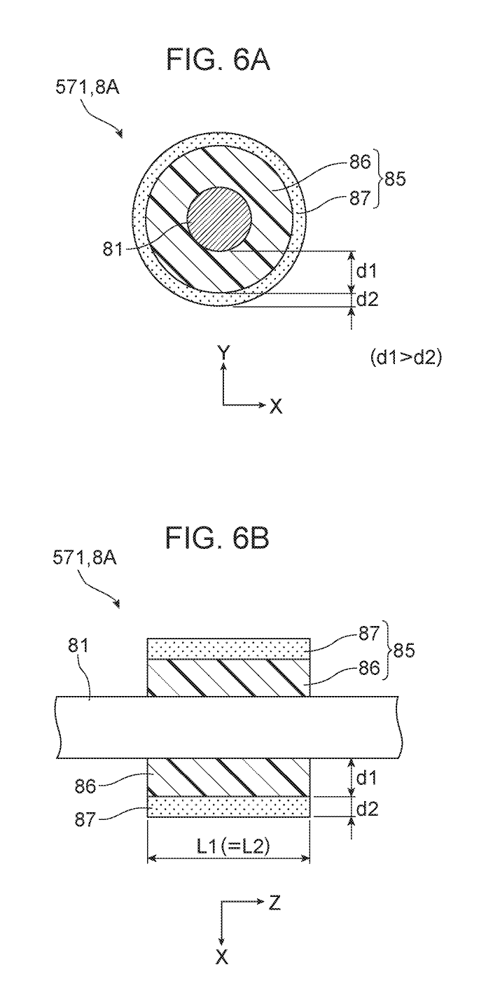

In the transport device 7A, the roller portions 83 of the roller member 8A used as the driving roller 571, in particular, are composed of roller portions 85. As illustrated in FIGS. 6A and 6B, each roller portion 85 includes a first layer 86 provided on a portion of the outer peripheral surface of the rotating shaft 81 and a second elastic layer 87 provided on the outer peripheral surface of the first layer 86. Each roller portion 85 is structured such that the first layer 86 is made of a material having a coefficient of linear expansion α lower than that of the material of the second elastic layer 87.

In the first exemplary embodiment, the roller member 8A is made of materials described below.

The first layer 86 of the roller portion 85 is made of a synthetic resin (coefficient of linear expansion α1≈0.5 to 1.0×10⁻⁴/° C.), such as polyacetal (POM). The second elastic layer 87 of each roller portion 85 is made of a rubber (coefficient of linear expansion α2≈2.0×10⁻¹/° C.), such as ethylene propylene diene rubber (EPDM).

The rotating shaft 81 is made of a metal (coefficient of linear expansion α3≈0.1 to 1.6×10⁻⁴/° C.), such as stainless steel.

In the first exemplary embodiment, each roller portion 85 is structured such that a thickness d1 of the first layer is greater than a thickness d2 of the second elastic layer 87 (d1>d2). The thickness d1 of the first layer 86 may be, for example, equal to or greater than 1.9 times the thickness d2 of the second elastic layer 87.

In the first exemplary embodiment, the thickness d1 of the first layer 86 is in the range of 3.5 to 6.5 mm, and the thickness d2 of the second elastic layer 87 is in the range of 1.0 to 4.0 mm.

In the first exemplary embodiment, the roller portion 85 is structured such that a length L2 of the second elastic layer 87 in the axial direction D is equal to a length L1 of the first layer 86 in the axial direction D (L2=L1).

A roller diameter K1 (FIG. 5) of each roller portion 85 is in the range of, for example, 14 to 15 mm. Although the roller diameter K1 of each roller portion 85 is greater than a roller diameter K2 of each roller portion 84 of the roller member 8N used as the driven roller 572 in the first exemplary embodiment, the roller diameter K1 is not limited to this.

The roller member 8A is manufactured by, for example, the following method. First, the required number of first layers 86 made of a synthetic resin are formed by, for example, injection molding. Next, the second elastic layer 87 is formed on the outer peripheral surface of each first layer 86 by, for example, rubber lining. Finally, the first layers 86 on which the second elastic layers 87 are formed are bonded to the rotating shaft 81 at predetermined positions. Thus, the roller member 8A is obtained.

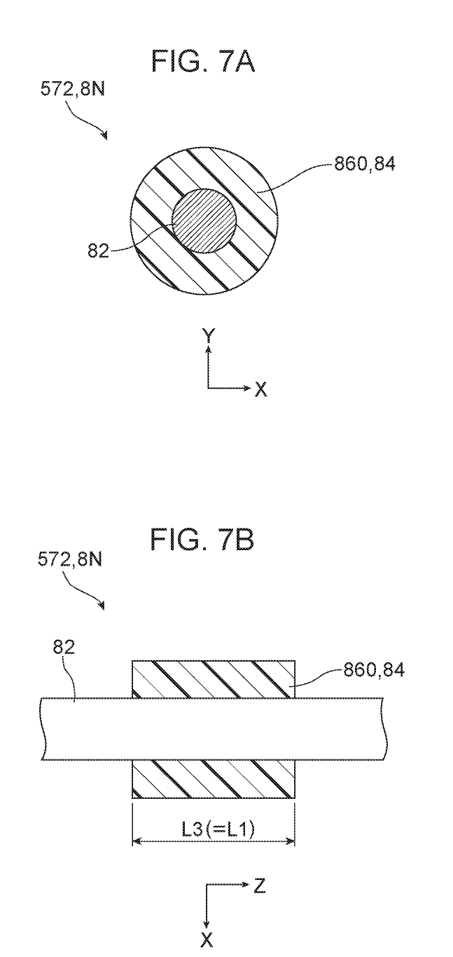

The roller portions 84 of the roller member 8N that serves as the driven roller 572 of the transport device 7A each include only a single layer 860 provided on a portion of the outer peripheral surface of the rotating shaft 82, as illustrated in FIGS. 7A and 7B.

The single layer 860 of each roller portion 84 of the roller member 8N is made of the same synthetic resin as that of the first layer 86 of each roller portion 85 of the roller member 8A. In other words, the single layer 860 is made of a material having a coefficient of linear expansion α lower than that of the material of the second elastic layer 87 of each roller portion 85 of the roller member 8A.

Each roller portion 84 of the roller member 8N that serves as the driven roller 572 may have another layer structure or be made of another material. However, to reduce thermal expansion, for example, each roller portion 84 of the roller member 8N may include a layer made of a material having a coefficient of linear expansion lower than that of the material of the second elastic layer 87 of each roller portion 85 of the roller member 8A that serves as the driving roller 571, as in this example.

In the first exemplary embodiment, a length L3 of the single layer 860 of each roller portion 84 of the roller member 8N in the axial direction D is equal to the length L1 of the first layer 86 of each roller portion 85 of the roller member 8A in the axial direction D (L3=L1).

The roller diameter K2 (FIG. 5) of each roller portion 84 is in the range of, for example, 12.9 to 13.1 mm. The roller diameter K2 of each roller portion 84 is smaller than the roller diameter K1 of each roller portion 85 of the roller member 8A that serves as the driving roller 751 (K2<K1).

### Operation of Transport Device and Roller Members

The transport device 7A that constitutes the third discharge roller pair 57 is operated at least when the recording sheet 9 is transported along the second discharge transport path Rt4 in the single-sided or double-sided image forming operation (see FIGS. 3 and 4A). When the recording sheet 9 is transported, the transport device 7A is operated so that the driving roller 571 is rotationally driven in, for example, the forward direction and the driven roller 572 that is in contact with the driving roller 571 is rotated by the driving roller 571.

As illustrated in FIG. 3 and other drawings, the recording sheet 9 to be transported along the second discharge transport path Rt4 is discharged from the fixing process portion FN of the fixing device 4 and passes through the first discharge roller pair 51, which serves as an upstream portion of the first discharge transport path Rt3. Then, the recording sheet 9 passes through the gap between the discharge guide member 54 (second guide portion 54b) and the path switching member 56 (second guide portion 56c), which form the second discharge transport path Rt4, and is guided into the space between the driving roller 571, which is rotationally driven, and the driven roller 572 of the transport device 7A.

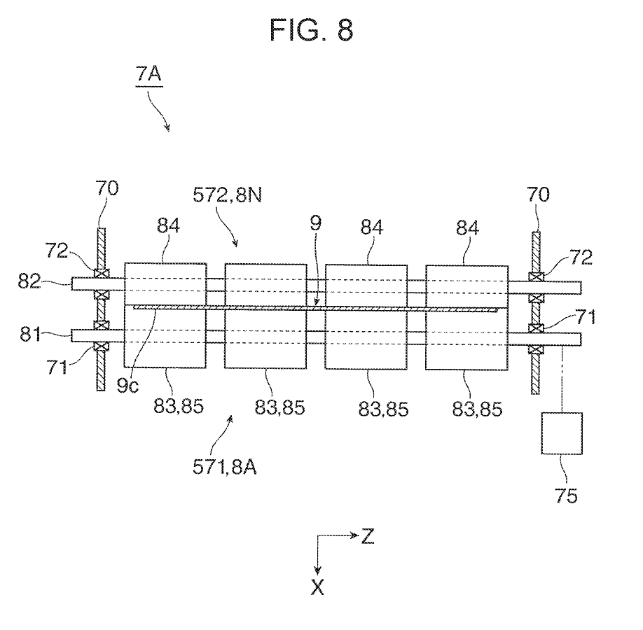

Next, as illustrated in FIGS. 4A and 8 and other drawings, the recording sheet 9 receives a transporting force and is transported while being nipped between the driving roller 571, which is rotationally driven, and the driven roller 572 of the transport device 7A. Thus, the recording sheet 9 is continuously or temporarily transported downstream along the second discharge transport path Rt4.

At this time, the driving roller 571 and the driven roller 572 of the transport device 7A tend to be heated and expanded because the recording sheet 9 that has been heated in the fixing process performed by the fixing device 4 is transported through the space therebetween while being in contact therewith. The driving roller 571, which comes into direct contact with a surface 9c of the recording sheet 9 to which the toner image has been thermally fixed (surface that has been brought into contact with the heating rotating body 41 of the fixing device 4) is more easily heated than the driven roller 572 is.

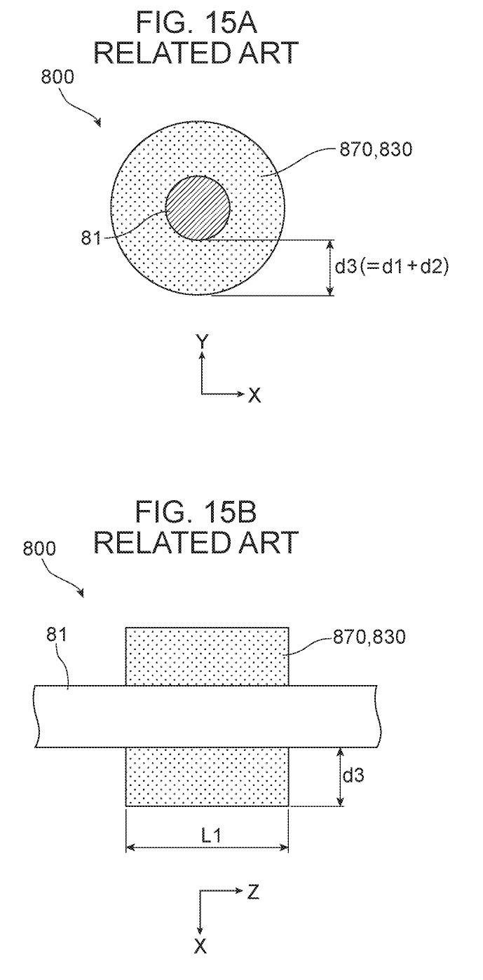

As described above, the driving roller 571 of the transport device 7A is constituted by the roller member 8A including the roller portions 85. Therefore, thermal expansion is less than that in the case where the driving roller 571 is constituted by, for example, a roller member 800 illustrated in FIGS. 15A and 15B that includes roller portions 830 which each include only a rubber layer 870 provided on at least a portion of the outer peripheral surface of the rotating shaft 81. A thickness d3 of the rubber layer 870 of each roller portion 830 of the roller member 800 illustrated in FIGS. 15A and 15B is equal to the sum (d1+d2) of the thicknesses of the two layers 86 and 87 of each roller portion 85 of the driving roller 571. A length L1 of each roller portion 830 in the axial direction D is equal to the length L1 of each roller portion 85 of the driving roller 571.

Thus, in the transport device 7A that constitutes the third discharge roller pair 57, even when the roller portions 85 of the driving roller 571 are continuously heated by plural recording sheets 9 that have passed through the fixing device 4, the transport speed of the recording sheets 9 does not easily vary (increase) due to an increase in the roller diameter K1 caused by thermal expansion of the roller portions 85.

Thus, even when the transport device 7A successively transports the recording sheets 9 that have passed through the fixing device 4, the transport speed of the recording sheets 9 does not easily vary.

In addition, each roller portion 85 of the driving roller 571 of the transport device 7A includes the second elastic layer 87 as the outermost layer thereof. Therefore, the transport device 7A has higher performance in transporting the recording sheet 9 than a transport device including a driving roller 571 with roller portions without the second elastic layers 87. Thus, the recording sheet 9 may be reliably transported.

In the image forming apparatus 1, as illustrated in FIG. 3, the discharge guide member 54 is disposed so as to protrude in the region between the first discharge roller pair 51 and the third discharge roller pair 57 so that the second discharge transport path Rt4, in particular, is bent at least once. Therefore, when, for example, the transport speed of the third discharge roller pair 57 disposed at the downstream side is increased due to thermal expansion thereof, there is a risk that the problem described below will occur.

However, in the image forming apparatus 1, such a risk may be reduced because the third discharge roller pair 57 is constituted by the above-described transport device 7A (in particular, since the roller member 8A is used).

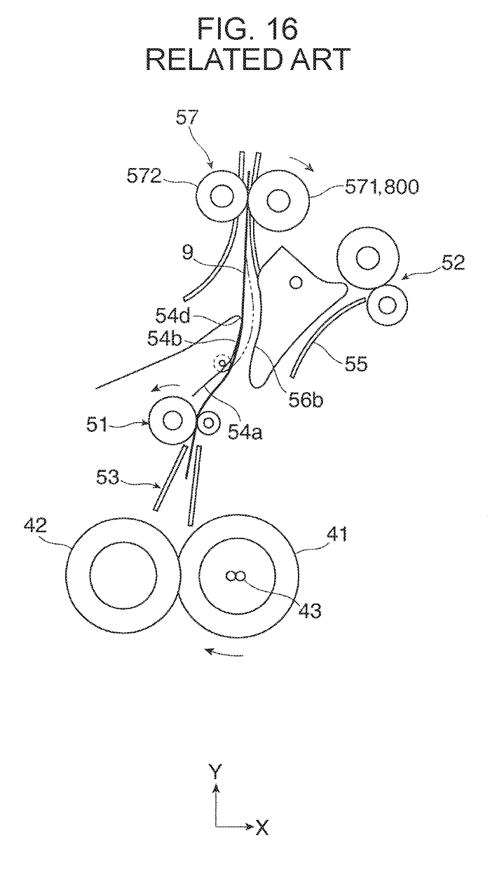

In the image forming apparatus 1, when the transport speed of the third discharge roller pair 57 is not increased due to thermal expansion of the driving roller 571, for example, the recording sheet 9 is transported through the region between the first discharge roller pair 51 and the third discharge roller pair 57 (along the discharge guide member 54 in practice) while being curved substantially along a portion of the second discharge transport path Rt4 that is curved once, as shown by the two-dot chain line in FIG. 16. The recording sheet 9 is transported in this way because the transport speed of the first discharge roller pair 51 is set to be slightly lower than the transport speed of the third discharge roller pair 57.

Thus, the recording sheet 9 is transported without coming into contact with the discharge guide member 54 or while being in slight contact with the discharge guide member 54.

However, when the transport speed of the recording sheet 9 is increased due to thermal expansion of the driving roller 571 of the third discharge roller pair 57, the amount by which the third discharge roller pair 57 transports the recording sheet 9 becomes greater than the amount by which the first discharge roller pair 51 transports the recording sheet 9.

Therefore, in such a case, the portion of the recording sheet 9 between the first discharge roller pair 51 and the third discharge roller pair 57 is straightened by being pulled by a larger amount toward the first discharge roller pair 51, as shown by the solid line in FIG. 16. Accordingly, the recording sheet 9 is transported while being pressed against the portion of the discharge guide member 54 that protrudes in the region between the first discharge roller pair 51 and the third discharge roller pair 57 (for example, a corner portion 54d that protrudes by a largest amount).

As a result, there is a risk that line-shaped contact marks will be formed on portions of the recording sheet 9 that are pressed against portions of the discharge guide member 54.

The above-described problem tends to occur when, for example, coated paper or cardboard (paper having a basis weight of 106 g/m² or more) is used as the recording sheet 9 or when the double-sided image forming operation is continuously performed. If the above-described problem occurs when the recording sheet 9 is discharged after a toner image is fixed to the second side thereof in the double-sided image forming operation, the image on one side (first side) of the recording sheet 9 will be damaged by the line-shaped contact marks formed thereon.

In contrast, in the image forming apparatus 1, the driving roller 571 of the third discharge roller pair 57, in particular, is constituted by the roller member 8A, so that thermal expansion of the driving roller 571 (roller portions 85) does not easily occur and the transport speed of the recording sheet 9 does not easily vary. As a result, the risk that the above-described line-shaped contact marks will be formed is reduced.

In the above-described transport device 7A, each roller portion 85 of the roller member 8A that serves as the driving roller 571 includes the first layer 86 made of a synthetic resin. Therefore, the costs, such as the material cost and manufacturing cost, are less than those of a roller member in which the first layer 86 is made of a material other than a synthetic resin (in particular, a material such as a metal).

In addition, in the above-described transport device 7A, each roller portion 85 of the roller member 8A that serves as the driving roller 571 is structured such that the thickness d1 of the first layer 86 is greater than the thickness d2 of the second elastic layer 87. Therefore, compared to a roller member in which the thickness d1 of the first layer 86 is equal to or smaller than the thickness d2 of the second elastic layer 87 or a transport device including the roller member, thermal expansion of each roller portion 85 of the roller member 8A may be more reliably reduced when the recording sheet 9 in the heated state that has passed through the fixing device 4 is transported. As a result, the risk that the transport speed at which the transport device 7A transports the recording sheet 9 will vary and the risk that the above-described problem will occur may be more reliably reduced.

In the image forming apparatus 1, the fixing device 4, which is an example of a heating device, is disposed below the transport device 7A including the roller member 8A as the driving roller 571. Therefore, the transport device 7A and the roller member 8A included therein are continuously heated by heat that travels upward from the heating rotating body 41 of the fixing device 4 at least during the image forming operation.

Although the transport device 7A and the roller member 8A included therein are heated by the heat that travels upward from the heating rotating body 41 of the fixing device 4, thermal expansion of each roller portion 85 does not easily occur. Accordingly, the transport speed of the recording sheet 9 does not easily vary due to thermal expansion of each roller portion 85. In addition, in the image forming apparatus 1 including the transport device 7A, the occurrence of other problems due to thermal expansion of each roller portion 85 of the roller member 8A included in the transport device 7A may be reduced.

Furthermore, in the image forming apparatus 1, the roller member 8N (FIGS. 7A and 7B) including the roller portions 84 which each include the single layer 860 made of a synthetic resin is used as the driven roller 572 of the transport device 7A. If, for example, the roller portions 84 of the driven roller 572 thermally expand, the pressing force applied by the driven roller 572 to the driving roller 571 (roller portions 85) increases, and there is a risk that, for example, the driven roller 572 will leave pressing marks on the recording sheet 9. However, in the above-described transport device 7A, the roller member 8N is used as the driven roller 572. Therefore, thermal expansion of the driven roller 572 is less than that in a transport device in which the roller member 800 (FIGS. 15A and 15B) including the roller portions 830 which each include only the rubber layer 870 is used as the driven roller 572. As a result, according to the transport device 7A, the risk that the roller portions 84 of the driven roller 572 will leave pressing marks on the recording sheet 9 due to thermal expansion of the roller portions 84 of the driven roller 572 is also reduced.

### Second Exemplary Embodiment

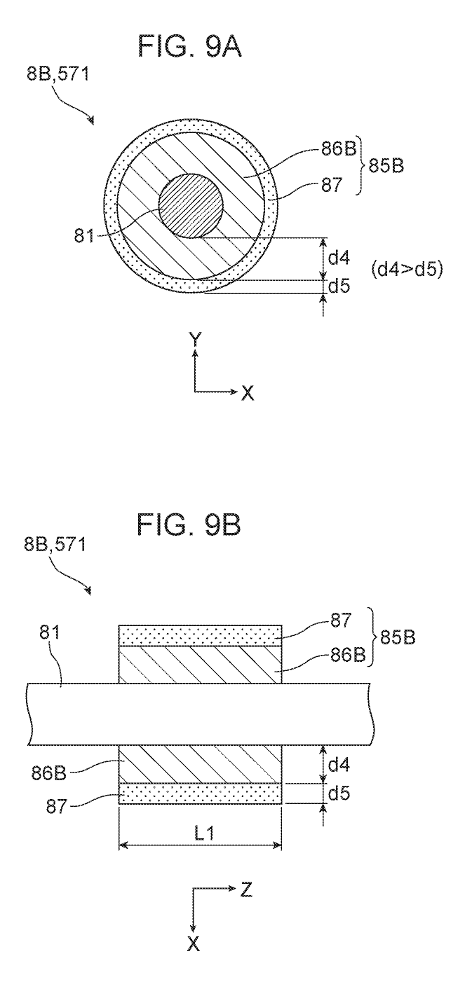

FIGS. 9A and 9B illustrate a roller member 8B according to a second exemplary embodiment.

The structure of this roller member 8B is the same as that of the roller member 8A according to the first exemplary embodiment except that the roller member 8B includes roller portions 85B which each include a first layer 86B made of the same material as the metal material of the rotating shaft 81. Accordingly, in FIGS. 9A and 9B, components that are the same as those of the roller member 8A are denoted by the same reference numerals.

Similar to the roller member 8A according to the first exemplary embodiment, the material (metal material) of the first layer 86B of the roller member 8B has a coefficient of linear expansion α lower than that of the material (rubber material) of the second elastic layer 87.

Similar to the roller member 8A according to the first exemplary embodiment, the roller member 8B may also be used as the driving roller 571 of the transport device 7A that constitutes the third discharge roller pair 57.

The sum (d4+d5) of thicknesses d4 and d5 of the first layer 86B and the second elastic layer 87, respectively, of each roller portion 85B of the roller member 8B is equal to the sum (d1+d2) of the thicknesses of the two layers 86 and of each roller portion 85 of the roller member 8A according to the first exemplary embodiment. The thicknesses d4 and d5 satisfy the relationship d4>d5. A length L1 of each roller portion 85B in the axial direction D is equal to the length L1 of each roller portion 85 of the roller member 8A according to the first exemplary embodiment.

The roller member 8B is manufactured by, for example, the following method.

First, the metal material of the rotating shaft 81 and the first layers 86B is cut, for example, to form the first layers 86B at predetermined positions and to form the rotating shaft 81. When the metal material is a cylindrical rod having a diameter equal to the outer diameter of the first layers 86B, the metal material may be cut to form the rotating shaft 81. Next, the second elastic layer 87 is formed on the outer peripheral surface of each first layer 86B by, for example, rubber lining. Thus, the roller member 8B is obtained.

Although a solid line is drawn between the rotating shaft 81 and the first layer 86B in FIGS. 9A and 9B to show the boundary for convenience, the solid line does not represent any portion when the rotating shaft 81 and the first layer 86B are formed by cutting the metal material as described above.

Similar to the roller member 8A of the first exemplary embodiment, even when each roller portion 85B is heated, thermal expansion of the roller member 8B is less than that of, for example, the roller member 800 illustrated in FIGS. 15A and 15B that includes the roller portions 830 which each include only the rubber layer 870 provided on at least a portion of the outer peripheral surface of the rotating shaft 81.

In addition, in the transport device 7A including the roller member 8B as the driving roller 571 of the third discharge roller pair 57, the transport speed of the recording sheet 9 does not easily vary due to thermal expansion of each roller portion 85B of the roller member 8B. Furthermore, since each roller portion 85B of the driving roller 571 of the transport device 7A includes the second elastic layer 87 as the outermost layer thereof, the transport device 7A has a high performance in transporting the recording sheet 9, and the recording sheet 9 may be reliably transported.

In the above-described transport device 7A, the first layer 86B of each roller portion 85B of the roller member 8B that serves as the driving roller 571 is made of a metal material. Therefore, the costs are somewhat higher than those in the case where the first layer is made of a synthetic resin, similar to the first layer 86 of each roller portion 85 of the roller member 8A according to the first exemplary embodiment. However, since the coefficient of linear expansion of the metal is lower than that of the synthetic resin as described above, thermal expansion is further reduced. Accordingly, variation in the transport speed of the recording sheet 9 is further reduced.

In addition, in the image forming apparatus 1 including the transport device 7A, the driving roller 571, in particular, is constituted by the roller member 8B, so that thermal expansion of the driving roller 571 (roller portions 85B) does not easily occur and the transport speed of the recording sheet 9 does not easily vary. As a result, the risk that the line-shaped contact marks described in the first exemplary embodiment will be formed is reduced.

### Third Exemplary Embodiment

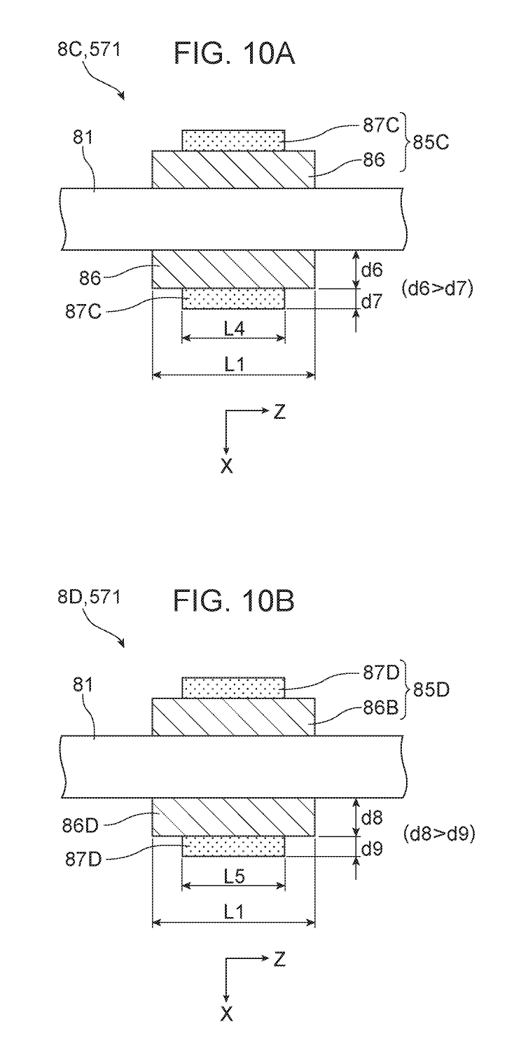

FIGS. 10A and 10B illustrate roller members 8C and 8D according to a third exemplary embodiment.

As illustrated in FIG. 10A, the structure of the roller member 8C is the same as that of the roller member 8A according to the first exemplary embodiment except that the roller member 8C includes roller portions 85C which each include a second elastic layer 87C having a length L4 less than the length L1 of the first layer 86 in the axial direction. The first layer 86 of the roller member 8C is made of a material (synthetic resin material) having a coefficient of linear expansion α lower than that of the material (rubber material) of the second elastic layer 87C.

As illustrated in FIG. 10B, the structure of the roller member 8D is the same as that of the roller member 8B according to the second exemplary embodiment except that the roller member 8D includes roller portions 85D which each include a second elastic layer 87D having a length L5 less than the length L1 of the first layer 86B in the axial direction. The first layer 86B of the roller member 8D is made of a material (metal material) having a coefficient of linear expansion α lower than that of the material (rubber material) of the second elastic layer 87D.

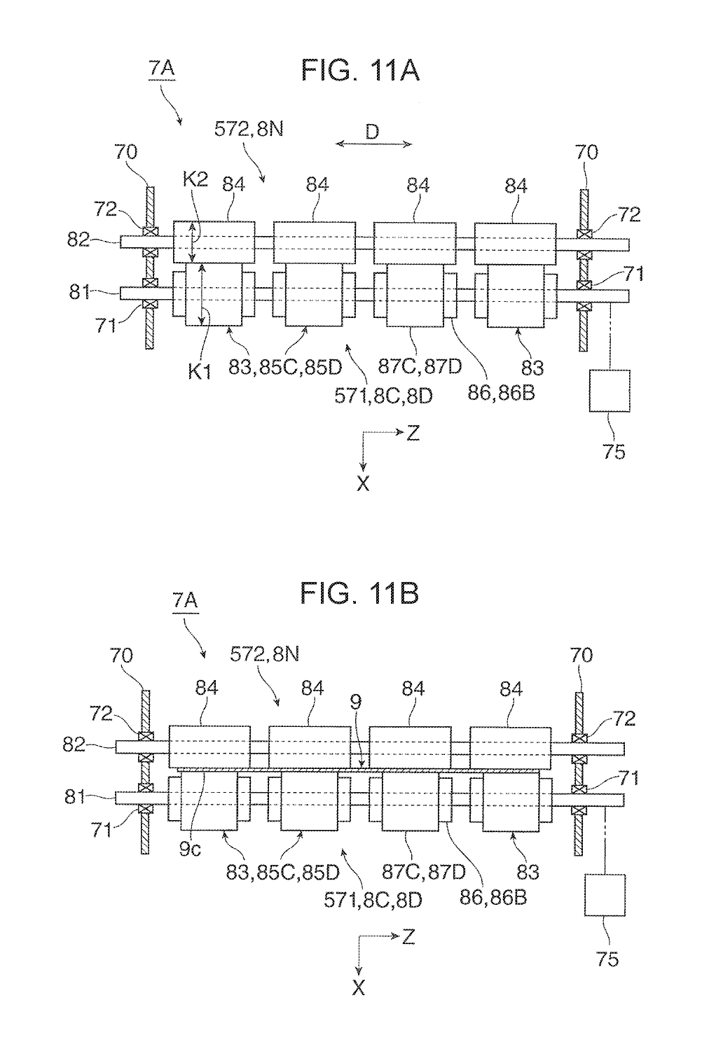

As illustrated in FIG. 11A, similar to the roller member 8A according to the first exemplary embodiment and the roller member 8B according to the second exemplary embodiment, each of the roller members 8C and 8D may also be used as the driving roller 571 of the transport device 7A that constitutes the third discharge roller pair 57.

The sum (d6+d7) of thicknesses d6 and d7 of the first layer 86 and the second elastic layer 87C, respectively, of each roller portion 85C of the roller member 8C is equal to the sum (d1+d2) of the thicknesses of the two layers 86 and of each roller portion 85 of the roller member 8A according to the first exemplary embodiment. The thicknesses d6 and d7 satisfy the relationship d6>d7.

The sum (d8+d9) of thicknesses d8 and d9 of the first layer 86B and the second elastic layer 87D, respectively, of each roller portion 85D of the roller member 8D is equal to the sum (d1+d2) of the thicknesses of the two layers 86 and of each roller portion 85 of the roller member 8A according to the first exemplary embodiment. The thicknesses d8 and d9 satisfy the relationship d8>d9.

Each roller portion 85C of the roller member 8C and each roller portion 85D of the roller member 8D both have a length L1 that is equal to the length L1 of each roller portion 85 in the axial direction D.

Similar to the roller member 8A of the first exemplary embodiment and the roller member 8B of the second exemplary embodiment, even when the roller portions 85C and 85D are heated, thermal expansion of the roller members 8C and 8D is less than that of, for example, the roller member 800 illustrated in FIGS. 15A and 15B that includes the roller portions 830 which each include only the rubber layer 870 provided on at least a portion of the outer peripheral surface of the rotating shaft 81.

In addition, the roller members 8C and 8D are structured such that the second elastic layers 87C and 87D respectively have the lengths L4 and L5 less than the length L1 of the first layers 86 and 86B. Therefore, thermal expansion and the costs are less than those of a roller member in which the length of the second elastic layer in the axial direction is equal to the length of the first layer in the axial direction.

In addition, referring to FIG. 11B, in the transport device 7A including the roller member 8C or 8D as the driving roller 571 of the third discharge roller pair 57, even when each roller portion 85C or 85D of the driving roller 571 is heated, the transport speed of the recording sheet 9 does not easily vary due to thermal expansion of each roller portion 85C of the roller member 8C or each roller portion 85D of the roller member 8D. Furthermore, since each roller portion 85C or 85D of the driving roller 571 of the transport device 7A includes the second elastic layer 87C or 87D as the outermost layer thereof, the transport device 7A has a high performance in transporting the recording sheet 9, and the recording sheet 9 may be reliably transported.

In the transport device 7A including the roller member 8D, the first layer 86B of each roller portion 85D of the driving roller 571 is made of a metal material. Therefore, the costs are somewhat higher than those in the case where the first layer is made of a synthetic resin, similar to the first layer 86 of each roller portion 85 of the roller member 8A according to the first exemplary embodiment. However, since the coefficient of linear expansion of the metal is lower than that of the synthetic resin as described above, thermal expansion is further reduced.

In addition, in the image forming apparatus 1 including the transport device 7A, the driving roller 571, in particular, is constituted by the roller member 8C or 8D, so that thermal expansion of each roller portion 85C or 85D of the driving roller 571 does not easily occur and the transport speed of the recording sheet 9 does not easily vary. As a result, the risk that line-shaped contact marks described above in the first exemplary embodiment will be formed is reduced.

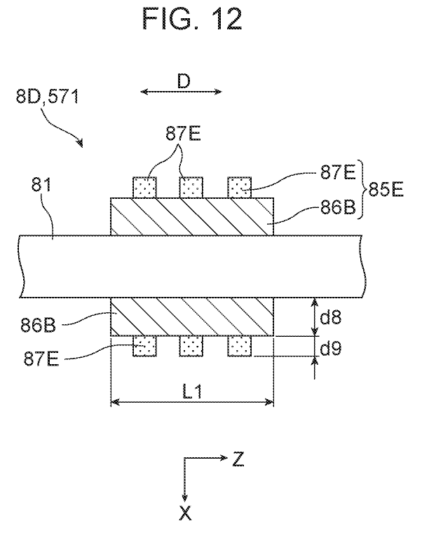

As illustrated in FIG. 12, for example, the roller member 8D may include roller portions 85E which each include plural second elastic layers 87E (three second elastic layers 87E in this example) instead of the above-described second elastic layer 87D. The second elastic layers 87E are arranged on the outer peripheral surface of the first layer 86B with predetermined gaps therebetween in the axial direction D.

The roller member 8C may also include roller portions which each include, instead of the above-described second elastic layer 87C, plural second elastic layers arranged on the outer peripheral surface of the first layer 86 with predetermined gaps therebetween in the axial direction D.

### Fourth Exemplary Embodiment

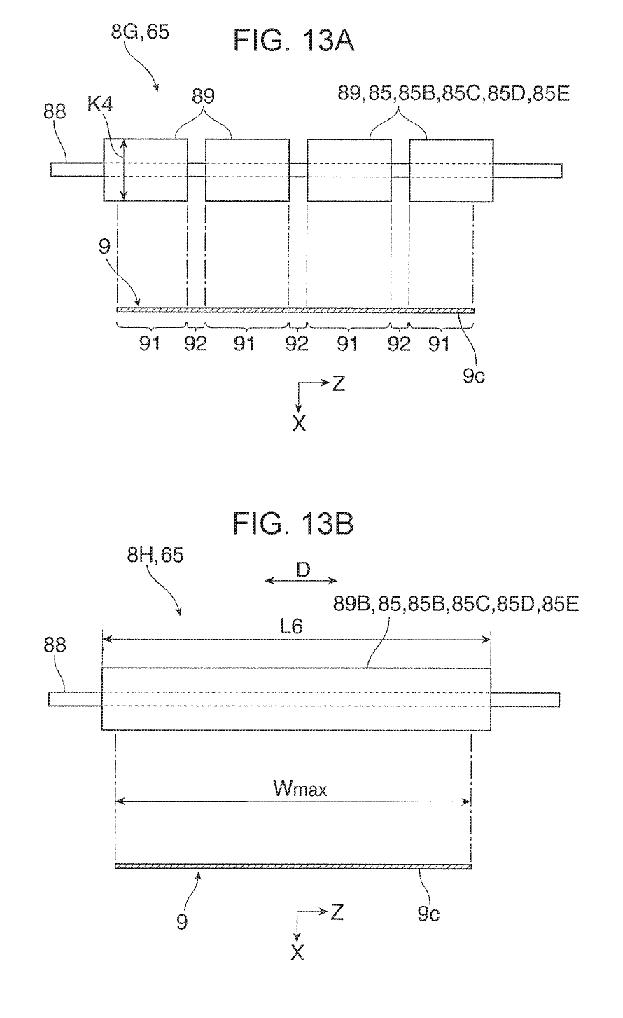

FIGS. 13A and 13B illustrate roller members 8G and 8H according to a fourth exemplary embodiment.

Referring to FIGS. 2 and 3, the roller members 8G and 8H may be used as, for example, a sheet feed roller 65 that is rotatably provided on a guiding corner portion of the discharge guide member 54 in the image forming apparatus 1. In the fourth exemplary embodiment, the sheet feed roller 65 is provided at a corner between the first guide portion 54a and the second guide portion 54b of the discharge guide member 54 in such a manner that roller portions thereof partially project. The sheet feed roller 65 may be regarded as a transport device without an opposing rotating body such as a roller member.

When the recording sheet 9 approaches the above-described guiding corner portion of the discharge guide member 54, which constitutes a portion of the second discharge transport path Rt4, while being transported along the second discharge transport path Rt4 of the image forming apparatus 1, the recording sheet 9 is brought into contact with the rotatable sheet feed roller 65 (transport device) constituted by the roller member 8G or 8H. Accordingly, the recording sheet 9 is prevented from sliding along the above-described guiding corner portion of the discharge guide member 54.

At this time, the sheet feed roller 65 is not rotationally driven by a rotational driving force transmitted thereto from a driving device, but is rotated by the recording sheet 9 in accordance with the amount of movement and speed of the recording sheet 9 when the recording sheet 9 is transported while being in contact with the roller portions of the sheet feed roller 65.

The roller member 8G illustrated in FIG. 13A, which serves as the sheet feed roller 65, includes a rotating shaft 88 that is rotatably provided on support members (not shown) or portions of the discharge guide member 54; and plural roller portions 89 including plural first layers 86 that are provided on portions the outer peripheral surface of the rotating shaft 88 with gaps therebetween, and second elastic layers 87 provided on the outer peripheral surfaces of the first layers 86. Each roller portion 89 is structured such that the first layer 86 is made of a material having a coefficient of linear expansion α lower than that of the material of the second elastic layer 87.

Similar to, for example, the rotating shaft 81 of the first exemplary embodiment, the rotating shaft 88 is made of a metal material. The structure of the roller portions 89 is similar to that of any of the roller portions 85 according to the first exemplary embodiment, the roller portions 85B according to the second exemplary embodiment, and the roller portions 85C, 85D, and 85E according to the third exemplary embodiment.

When the sheet feed roller 65 (transport device) constituted by the roller member 8G is used, even when the sheet feed roller 65 is heated by coming into contact with the recording sheet 9 that has been heated by the fixing device 4, thermal expansion of the roller portions 89 of the roller member 8G does not easily occur, similar to the roller portions 85, 85B, and 85C to 85E according to the first to third exemplary embodiments.

Since the fixing device 4, which is an example of a heating device, is disposed below the sheet feed roller 65 (transport device) constituted by the roller member 8G, the sheet feed roller 65 is continuously heated by heat that travels upward from the heating rotating body 41 of the fixing device 4 at least during the image forming operation. However, thermal expansion due to this heat also does not easily occur.

Thus, in the roller member 8G that serves as the sheet feed roller 65, variation in the feeding direction of the recording sheet 9 due to an increase in a roller diameter K4 of each roller portion 89 caused by thermal expansion of the roller portion 89 may be reduced. Since variation in the direction in which the recording sheet 9 is fed by the sheet feed roller 65 is reduced, the risk that the transporting path of the recording sheet 9 will be changed may also be reduced.

The roller member 8H illustrated in FIG. 13B, which serves as the sheet feed roller 65, includes a rotating shaft 88 that is rotatably provided on support members (not shown) or portions of the discharge guide member 54; and a roller portion 89B including a first layer 86 that continuously extends along a portion of the outer peripheral surface of the rotating shaft 88 and a second elastic layer 84 provided on the outer peripheral surface of the first layer 86. The roller portion 89B is structured such that the first layer 86 is made of a material having a coefficient of linear expansion α lower than that of the material of the second elastic layer 87.

Similar to, for example, the rotating shaft 81 of the first exemplary embodiment, the rotating shaft 88 is made of a metal material. The structure of the roller portion 89B is similar to that of any of the roller portions 85 according to the first exemplary embodiment, the roller portions 85B according to the second exemplary embodiment, and the roller portions 85C, 85D, and 85E according to the third exemplary embodiment. A length L6 of the roller portion 89B in the axial direction D is greater than a maximum passage width Wmax of the recording sheet 9 capable of coming into contact with and passing the roller portion 89B (L6>Wmax). When the roller portion 89B has a structure similar to that of any of the roller portions 85C, 85D, and 85E according to the third exemplary embodiment, the length L4 (L5, etc.) of the second elastic layer 87C (87D, 87E) may be less than the length L1 (=L6) of the first layer 86 (86b) and the maximum passage width Wmax of the recording sheet 9 as long as the length L1 (=L6) of the first layer 86 (86b) is greater than the maximum passage width Wmax of the recording sheet 9.

When the sheet feed roller 65 (transport device) constituted by the roller member 8H is used, even when the sheet feed roller 65 is heated by coming into contact with the recording sheet 9 that has been heated by the fixing device 4, thermal expansion of the roller portion 89B of the roller member 8H does not easily occur, similar to the roller portions 85, 85B, and 85C to 85E according to the first to third exemplary embodiments.

Since the fixing device 4, which is an example of a heating device, is disposed below the sheet feed roller 65 (transport device) constituted by the roller member 8H, the sheet feed roller 65 is continuously heated by heat that travels upward from the heating rotating body 41 of the fixing device 4 at least during the image forming operation. However, thermal expansion due to this heat also does not easily occur.

Thus, in the roller member 8H that serves as the sheet feed roller 65, variation in the feeding direction of the recording sheet 9 due to an increase in a roller diameter K4 of the roller portion 89B caused by thermal expansion of the roller portion 89B may be reduced.

When, in particular, the sheet feed roller 65 (transport device) constituted by the roller member 8H is used, the occurrence of uneven heating (reheating) of the recording sheet 9 is less than that in the case where the sheet feed roller 65 (transport device) constituted by the roller member 8G is used.

When the recording sheet 9 passes the sheet feed roller 65 (transport device) while being continuously in contact therewith, the roller portions (89) of the sheet feed roller 65 are heated so that heat is stored therein. Then, the roller portions (89) of the sheet feed roller 65 reheat the recording sheet 9 that subsequently comes into contact with and passes the roller portions (89).

When the sheet feed roller 65 (transport device) constituted by the roller member 8G is used, as illustrated in FIG. 13A, the roller portions 89 are provided on the rotating shaft 88 with gaps therebetween. Therefore, when the recording sheet 9 comes into contact with and passes the roller member 8G, one-side portions 91 of the recording sheet 9 that come into contact with the roller portions 89 are reheated. However, one-side portions 92 of the recording sheet 9 that pass through regions where the roller portions 89 are not present (where only the rotating shaft is present) do not come into contact with the roller portions 89 and are therefore hardly reheated. As a result, one side of the recording sheet 9 that comes into contact with and passes the roller member 8G is unevenly heated over the entire area thereof.

When the recording sheet 9 is unevenly heated as described above, there is a risk that, for example, the glossiness of the image formed on the recording sheet 9 will differ between the one-side portions 91 and 92.

In contrast, when the sheet feed roller 65 (transport device) constituted by the roller member 8H is used, as illustrated in FIG. 13B, the length L6 of the roller portion 89B is greater than the maximum passage width Wmax of the recording sheet 9. Accordingly, when the recording sheet 9 comes into contact with and passes the roller member 8H, one side of the recording sheet 9 comes into contact with and reheated by the roller portion 89B over the entire area thereof. Thus, the occurrence of uneven heating is reduced over the entire area of one side of the recording sheet 9. Therefore, in this case, the risk that above-described problem due to uneven heating of the recording sheet 9 will occur may be reduced.

### Fifth Exemplary Embodiment

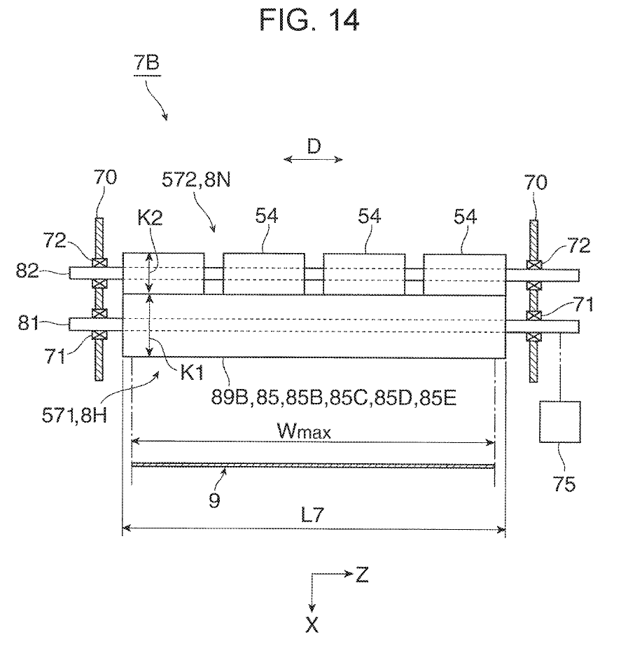

FIG. 14 illustrates a transport device 7B according to a fifth exemplary embodiment.

The structure of the transport device 7B is the same as that of the transport device 7A according to the first to third exemplary embodiments except that the roller member 8H according to the fourth exemplary embodiment is used as the driving roller 571 of the third discharge roller pair 57.

In other words, the driving roller 571 of the transport device 7B is structured so that a length L7 of the roller portion 89B is greater than the maximum passage width Wmax of the recording sheet 9 capable of coming into contact with and passing the roller portion 89B (L7>Wmax).

In the transport device 7B including the roller member 8H as the driving roller 571 of the third discharge roller pair 57, even when the roller portion 89B of the driving roller 571 is heated by the recording sheet 9 that has been heated by the fixing device 4, thermal expansion of the roller portion 89B of the roller member 8H does not easily occur. Accordingly, variation in the transport speed of the recording sheet 9 due to the thermal expansion also does not easily occur. Furthermore, since the roller portion 89B of the driving roller 571 of the transport device 7B includes the second elastic layer (87) as the outermost layer thereof, the transport device 7B has a high performance in transporting the recording sheet 9, and the recording sheet 9 may be reliably transported.

When the roller portion 89B of the driving roller 571 of the transport device 7B is heated by the recording sheet 9 and heat is stored therein, the recording sheet 9 that is subsequently transported may be reheated by the roller portion 89B. Even in such a case, one side of the recording sheet 9 may be evenly reheated over the entire area thereof.

### Other Exemplary Embodiments

In the first to third and fifth exemplary embodiments, the roller members 8A to 8D and 8H are used as the driving roller 571 of the third discharge roller pair 57. However, the roller members 8A to 8D and 8H are not limited to this, and may be used as at least one roller of any other roller pair.

For example, the roller members 8A to 8D and 8H may be used as both the driving roller 571 and the driven roller 572 of the third discharge roller pair 57.

The roller members may be used as at least one roller of a roller pair through which the recording sheet 9 is transported after being heated and that is required to reduce thermal expansion thereof. Other examples of roller pairs include the first discharge roller pair 51. In the case where the sheet supplying device 3 includes a drying device as an example of a heating device that heats the recording sheet 9 to dry the recording sheet 9, the roller members may be used as at least one roller of a transport roller pair that transports the recording sheet 9 that has been heated and dried by the drying device from the sheet supplying device 3 to an image forming section.

In the transport device including any of the roller members 8A to 8D and 8H, the pair of roller members is not limited to a roller pair that is rotationally driven by a rotational driving force transmitted thereto from a driving device, and may instead be rotated by the recording sheet 9 that is guided into and transported through the roller pair.

The roller members 8A to 8D and 8H are not limited to those included in the transport devices 7A and 7B that transport the recording sheet 9 in the image forming apparatus 1. The roller members 8A to 8D and 8H may instead be used as at least one of two roller members that are included in a transport device and transport a transport object other than the recording sheet 9 while nipping the transport object therebetween.

In this case, the transport object may be any object that is capable of being transported while being nipped between the two roller members and that is transported to the transport device after being heated. In addition, in this case, the transport device may be a device in which at least one of the two roller members is required to reduce thermal expansion thereof due to heat from the transport object transported after being heated at a position in front of the transport device or heat that travels upward from a heating device disposed below the transport device.

The image forming apparatus that includes any of the roller members 8A to 8D and 8H or the transport device including any of the roller members is not limited to an image forming apparatus that forms a monochrome image by using a toner of a single color as described in the first to fifth exemplary embodiments, and may instead be another type of image forming apparatus.

For example, the image forming apparatus may be an image forming apparatus that forms a multicolored (color) image by using toners of plural colors, or an image forming apparatus that forms an image by ejecting ink droplets. In the case where the image forming apparatus forms a multicolored image by using toners of plural colors, the image forming device 2 according to the first exemplary embodiment may be replaced by, for example, plural image forming devices that form toner images of respective colors and an intermediate transfer device. The intermediate transfer device carries the toner images of the respective colors, which are formed by the image forming devices and transferred thereto, and transports the toner images to a position where the toner images are retransferred to the recording sheet 9.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A roller member comprising:
a rotating shaft; and
a roller portion including
a first layer provided on at least a portion of an outer peripheral surface of the rotating shaft, and
a second elastic layer provided on at least a portion of an outer peripheral surface of the first layer,
wherein the first layer is made of a material having a coefficient of linear expansion lower than a coefficient of linear expansion of a material of the second elastic layer.

2. The roller member according to claim 1, wherein the first layer is made of a synthetic resin.

3. The roller member according to claim 1, wherein a thickness of the first layer is greater than a thickness of the second elastic layer.

4. The roller member according to claim 1, wherein a length of the second elastic layer in an axial direction is less than a length of the first layer in the axial direction.

5. The roller member according to claim 1, wherein a length of the roller portion including the first layer and the second elastic layer in an axial direction is greater than a maximum passage width of a transport object that is capable of coming into contact with and passing the roller portion.

6. The roller member according to claim 1, wherein the roller member is rotationally driven by a rotational driving force transmitted thereto.

7. A transport device comprising:
two roller members that rotate while being in contact with each other and transport a transport object while nipping the transport object,
wherein at least one of the two roller members is the roller member according to claim 1.

8. The transport device comprising:
two roller members that rotate while being in contact with each other and transport a transport object while nipping the transport object, wherein at least one of the two roller members is the roller member according to claim 1; and
a driving device that transmits a rotational driving force to at least one of the two roller members,
wherein the roller member is rotationally driven by the rotational driving force transmitted thereto from the driving device.

9. An image forming apparatus comprising:
the roller member according to claim 1.

10. An image forming apparatus comprising:
the transport device according to claim 7.

11. The image forming apparatus according to claim 9, further comprising:
a heating device disposed below the roller member.

12. The image forming apparatus according to claim 10, further comprising:
a heating device disposed below the transport device.
